(19) United States
(12) Patent Application Publication
(10) Pub. No.: US 2011/0282698 A1
(43) Pub. Date: Nov. 17, 2011

(54) System For Marketing Using Text Messaging

(76) Inventors: Samuel A. Meers, Kansas City, MO (US); Ronald R. Rowe, Weston, MO (US)

(21) Appl. No.: 13/192,169

(22) Filed: Jul. 27, 2011

Related U.S. Application Data
(63) Continuation-in-part of application No. 12/642,512, filed on Dec. 18, 2009.
(60) Provisional application No. 61/240,539, filed on Sep. 8, 2009.

(51) Int. Cl. G06Q 40/00; G06Q 30/00

(52) U.S. Cl. 705/4; 705/26.4; 705/14.64; 705/14.42

(57) ABSTRACT

announcement broadcast by a media source. A keyword is associated with the media source. Instructions are included in the announcement to send an initial text message including the keyword, to a text messaging number, to receive a quote for the product. The initial text message including the keyword is then sent from a wireless telecommunication device in response to the announcement having been heard by the user of the device. In response, the quote is sent to the to the telecommunication device.

### RELATED APPLICATIONS

This application is a continuation-in-part of U.S. Non-Provisional patent application Ser. No. 12/642,512 filed Dec. 18, 2009 which claims the benefit of U.S. Provisional Patent Application No. 61/240,539, filed Sep. 8, 2009, the disclosures of all of which are hereby incorporated by reference.

### BACKGROUND

Currently, insurance is marketed using a variety of technologies. Some processes involve the use of computer technologies. These methods typically involve establishing a website which can be accessed online. Using the website, potential clients have been able to access insurance coverage information. Additionally, potential clients have been able to request a price quote by submitting personal information relevant to the coverage desired. Once received, this information is used by the insurance company to generate a rate quote. Once the quote is generated, it can be displayed on the user's computer promptly after submission, or instead, the quote can be emailed to them.

An alternative to these web-based methods is the even more traditional over-the-phone process. This process involves the potential client calling a designated phone number for the insurance carrier, and requesting a quote. In order to develop the correct rate, either a teleprompt system or live sales person is used to gather the necessary personal information from the consumer. Once the rate is established, it is then communicated directly to the client over the phone using live or automated voice.

### SUMMARY

Disclosed are embodiments of systems and methods for marketing a product using an announcement broadcast by a media source. In one embodiment, a unique keyword is established for each of one or more media sources. These media sources broadcast announcements, each of which include a particular keyword associated with a respective media source, and instructions to send a text message including the keyword to a text messaging number for a quote. The text message including the keyword is then sent from a wireless telecommunication device in response to the announcement having been heard by the user of the device. In response, the quote is sent to the to the telecommunication device.

### BRIEF DESCRIPTION OF THE DRAWINGS

FIG. 1 is a diagram showing exemplary components of the present system;

FIG. 2 is a diagram showing an exemplary set of high-level steps performed in operation of the present system; and

FIG. 3 is a diagram showing an exemplary set of steps performed in operation of the present system, in an alternative embodiment.

### DETAILED DESCRIPTION

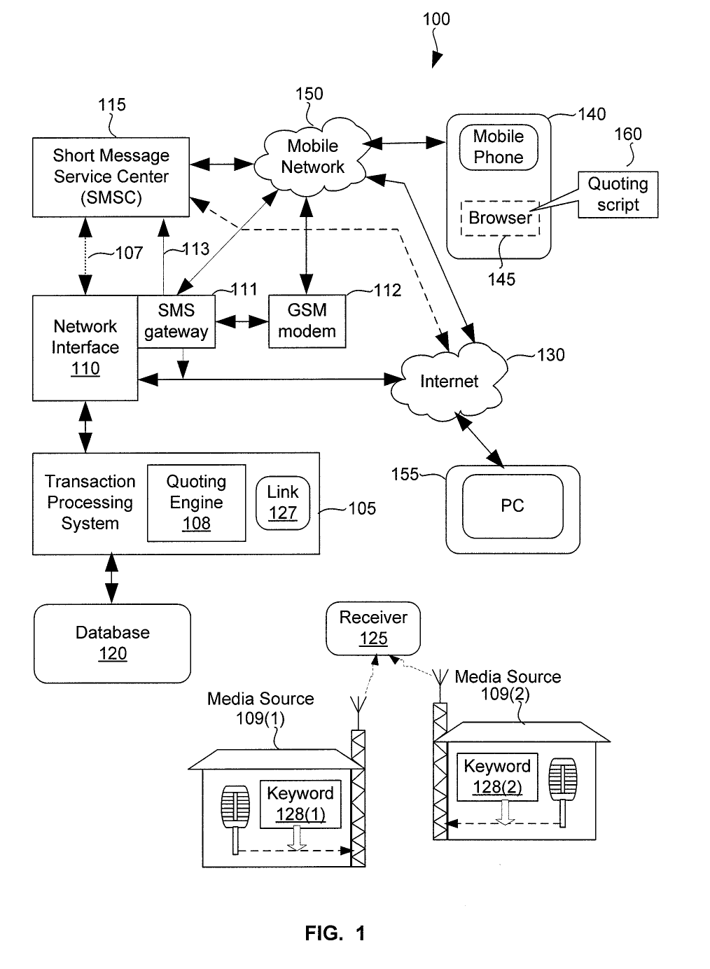

FIG. 1 is a diagram showing exemplary components of the present system 100. As shown in FIG. 1, system 100 includes a transaction processing computer system 105 connected to a database 120 and a network interface 110. In an exemplary embodiment, network interface 110 is coupled to the Internet 130 and also to an SMS (Short Message Service) gateway 111, described further below.

In one embodiment, transaction processing computer system 105 communicates with a Short Message Service Center (SMSC) 115 via network interface 110, SMS gateway 111, and a wireless connection to the mobile network 150 using a GSM modem 112. SMSC 115 is a network element in the mobile telephone network which receives stores and delivers SMS messages (described below). Alternatively, transaction processing system 105 may communicate with SMSC 115 via network interface 110 and the Internet 130 or a direct, e.g., leased line, connection 107.

Communications, such as system messages, user queries and responses, are sent between transaction processing system 105 and a user's wireless telecommunication device 140 via the Internet and/or the mobile network 150. The Internet is also used to send communications between processing system 105 to a user's personal computer (PC) 155. The present system utilizes a web browser 145 or a text message service on the user's wireless telecommunication device 140 to display messages sent from transaction processing system 105. A quoting script or template 160 is displayed on web browser 145 to facilitate acquisition of information input by the user.

In operation, a listener/user (not shown) receives a broadcast transmission from a media source 109(*) [where the “*” indicates a specific one of the media sources] via receiver 125. Two media sources, 109(1) and 109(2) are shown in FIG. 1, but certain embodiments of the present system are operative with as few as one, or more than two, media sources 109. The transmission is typically an AM or FM broadcast band transmission, but may, alternatively, be any other type of transmission such as digital HD radio or a television signal.

SMS gateway 111 is a device which assists in SMS transit, transforming messages to mobile network traffic, and vice versa, allowing transmission and receipt of SMS messages. SMS is a communication service employed in the GSM mobile communication system, using standardized communications protocols allowing the interchange of short text messages (140 bytes, or 160 7-bit characters) between mobile telephone devices. GSM (Global System for Mobile communications) is the de facto cellular network standard for mobile phones. Mechanisms for connecting an SMS gateway to the mobile network include Direct To SMSC Gateways, wireless connections, and IP SMS connections.

In an exemplary embodiment, a wireless connection is used to connect SMS gateway 111 to the mobile network 150, typically via a GSM modem 112. The SMS gateway 111 controls the GSM device 112 and uses it to send and receive SMS messages.

In an alternative embodiment, SMS gateway 111 is a Direct To SMSC Gateway, which is a device that allows SMS text messages to be sent and/or received by email, from web pages or from software applications. This type of Gateway connects directly to SMSC 115 via the Internet or direct connection 107. In general, when a text message (SMS message) is sent from one entity to another, the message is stored in the SMSC, which delivers the message to the destination entity on demand. This procedure is known as a ‘store and forward’ operation. SMS Gateway 111 converts the message format into a format understood by the SMSC, typically the SMPP protocol. Typically, Direct To SMSC Gateways are used for high volume messaging.

Another mechanism for connecting SMS gateway 111 to the mobile network 150 is an IP (Internet Protocol) SMS connection 113. With this type of connection, SMS gateway 111 is connected directly to SMSC 115 via the Internet or via line 113. In this case the SMS messages are sent directly to the SMSC of the service provider using a protocol such as TCP/IP. The SMS gateway 111 manages the link and converts messages to and from the appropriate SMS protocol (CIMD2, UCP, SMPP, HTTP, etc.).

In some embodiments, quoting engine 108 and database 120 are maintained by an insurance provider. In certain embodiments the insurance provider can be a health insurance company.

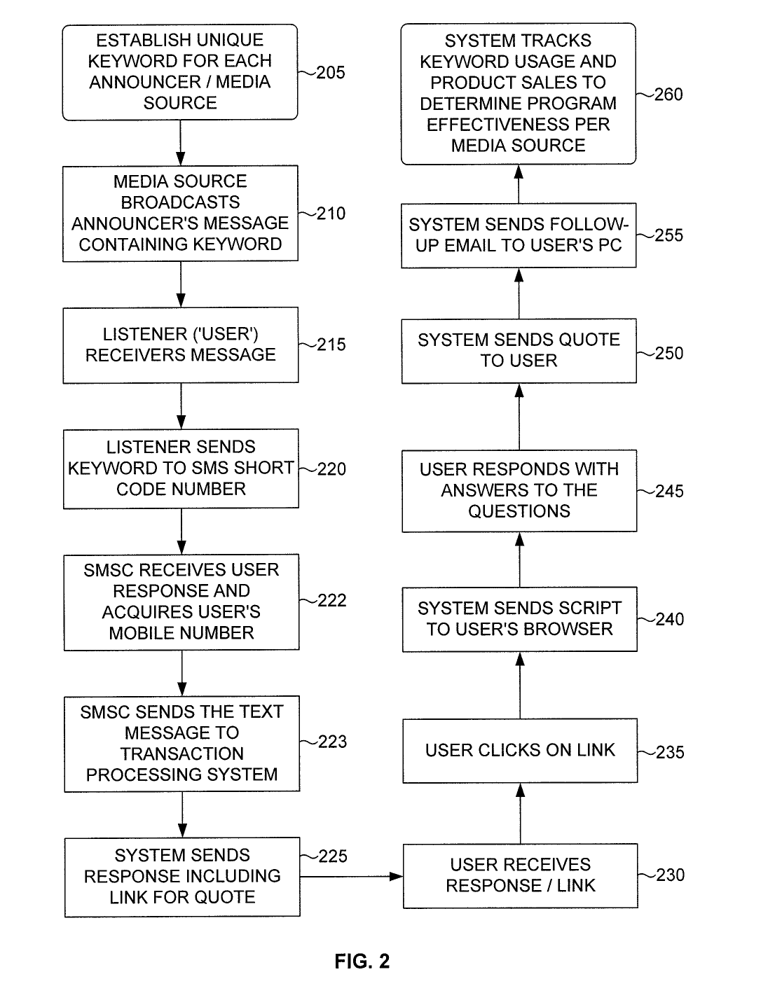

FIG. 2 is a diagram showing an exemplary set of high-level steps performed in operation of the present system. The system described herein employs a broadcast media announcer, for example, a ‘disc jockey’, who is well-known in a particular area. Other types of media persona, e.g., celebrities and sports figures, are also candidates for the types of announcers that may be used in accordance with the presently described system and method.

As shown in FIG. 2, at step 205, a unique keyword 128 is associated with each announcer or broadcast media source which is to be used with a particular marketing program for an advertiser. These keywords will be used by the advertiser to distinguish between different media sources, so that the advertiser is able to identify which announcer or media source or outlet a listener is responding to. It should be appreciated that the term “keyword” as used in this application should not be limited to character strings that are exclusively letters. Keywords 128 may be partially or wholly numeric, or even symbolic. Furthermore, in various embodiments, the keywords may alternatively be spoken into the phone or otherwise administered. An analysis of the keywords submitted by system users also enables comparing the effectiveness of different announcers and/or media sources.

At step 210, the media source broadcasts the announcer's message containing a keyword 128, as well as a number to which to send a text message, e.g., an SMS ‘short code’ number. More specifically, the announcer instructs listeners to submit a message to a text messaging number which includes the keyword. At step 215, a listener receives the announcer's message on the listener's radio or television set.

At step 220, the listener (hereinafter ‘user’) uses the SMS ‘short code’ number to send a text message to SMSC 115, via wireless telecommunication device, e.g., mobile phone 140. The text message includes the keyword 128 which the user received (i.e., heard or viewed) in the announcer's message. In the process of receiving the user's text message, SMSC 115 acquires the user's mobile phone number at step 222. SMSC 115 then sends the text message containing keyword 128, along with the user's mobile phone number, to transaction processing system 105, via the Internet or line 107, at step 223.

At step 225, transaction processing system 105 sends a response to the user, via mobile network 150. The response includes a link, which is displayed on web browser 145 in the user's wireless telecommunication device, e.g., wireless telecommunication device/mobile phone 140, when received at step 230. This link contains the URL of a quoting engine 108 in processing system 105. When the link activated (i.e., ‘clicked on’) by the user at step 235, browser 145 is opened, and the IP address of the mobile phone is sent to the quoting engine 108 at the URL designated by the link. Quoting engine 108 then sends a quoting script 160, containing a set of questions, to user's browser 145 at step 240. In one embodiment, the questions include the user's age, sex, and zip code. These three pieces of information are used to formulate a quote (in step 250, below). It should be noted that the term “quote”, as used herein, should be interpreted broadly in that a “quote” may be a rate prediction, estimate, or other type of information related to a particular product or service. Thus, no degree of definiteness in terms of accuracy or form should be assigned to this term unless otherwise specified. Furthermore, in certain embodiments, the quote may be a minimum rate which presumes conditional ideals, or the quote may be presented in the form of a periodic fee required for the purchase of insurance. For example, the quote might be displayed as a monthly payment that would be required in order to participate in a particular insurance plan. Communications between browser 145 and quoting engine 108 are sent via the Internet.

At step 245, the user answers the questions, which include a request for the user's email address, and clicks on a link displayed in the script to send the answers back to quoting engine 108. At step 250, quoting engine 108 processes the user's answers and sends a quote based thereon to the user's browser 145. In an exemplary embodiment, quoting engine 108 then sends a follow-up email message to the email address submitted by the user, at step 250. This follow-up email may contain further instructions for requesting a quote from the advertiser.

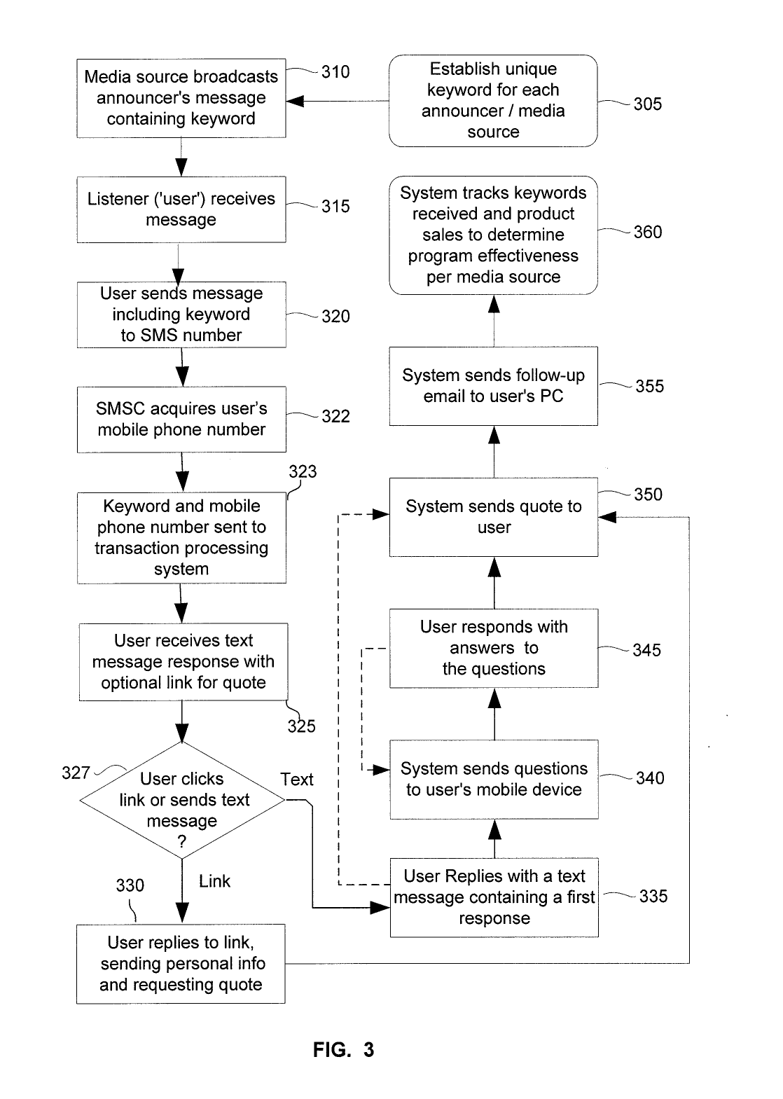

FIG. 3 is a diagram showing an exemplary set of high-level steps performed in operation of an alternative embodiment of the present system. As shown in FIG. 3, at step 305, a unique keyword 128(*) [where the “*” indicates a specific one of the keywords] is associated with each announcer and/or broadcast media source which is to be used with a particular marketing program for an advertiser. As an example, FIG. 1 shows two keywords, 128(1) and 128(2), respectively associated with media sources 109(1) and 109(2).

At step 310, a media source 109 broadcasts an announcer's message containing keyword 128(*), as well as a number, e.g., an SMS ‘short code’ number, to which to send a text message. More specifically, the announcer instructs listeners to submit a message, which includes the keyword, to a text messaging number. At step 315, a listener receives the announcer's message on the listener's radio or television set.

In alternative embodiments, instead of using a broadcast to request the text messages like in steps 310 and 315, other media, e.g., printed matter, postal mail, out-of-home media channel such as outdoor board, taxi or bus signs, etc., can display the keyword and short code to generate quote inquiries using SMS.

At step 320, the media receiver, e.g., listener (or ‘user’) uses the SMS ‘short code’ number to send an initial text message to SMSC 115, via wireless telecommunication device, e.g., mobile phone 140. The initial text message comprises the keyword which the user received (i.e., heard or viewed) in the announcer's message. In the process of receiving the user's initial text message, SMSC 115 acquires the user's mobile phone number at step 322. SMSC 115 then sends the text message containing the keyword, along with the user's mobile phone number, to transaction processing system 105, via the Internet or line 107, at step 323.

At step 325, the user receives a response, via mobile network 150, from transaction processing system 105. The response is a text message including instructions for requesting a quote and an optional link 127, which are displayed on the user's wireless telecommunication device, e.g., mobile phone 140. The instructions include required information that must be received from the telecommunication device in order to generate the quote. The instructions indicate that the user may initiate the quoting process by either (1) clicking on the link, (2) responding via a text message containing certain information such as the user's age, or (3) calling a specified telephone number. Link 127 contains the URL of a quoting engine 108 in processing system 105. As indicated at step 327, if the user has activated (‘clicked on’) link 127, the link is activated, the IP address of the mobile phone is sent to the quoting engine 108 at the URL designated by the link, at step 330, and processing continues at step 350, described below. Otherwise, processing continues as follows.

At step 335, the user replies by sending a ‘first response’ text message with information responsive to the message received in step 325. In one embodiment, this ‘first response’ message includes the user's age. In an alternative embodiment, the ‘first response’ message includes multiple items, such as the user's age, gender, and zip code. Regardless, the quoting engine records the information received for future use in generating a quote.

At step 340, in response to receiving the ‘first response’ text message, if additional information is required from the user, quoting engine 108 records the information included in the response, sends a text message acknowledging the receipt of the initial information provided (e.g., age), and in embodiments, requests additional information. A second text transmitted by the quoting engine can request information relating to sex. For example, a second text can express “thanks for sending your age. Reply to text with M for male or F for female.” Returning again to step 345, the user is then able to send a second text message response from mobile phone 140 with an answer to the requested information by texting back one of letters “M” or “F”.

Upon receipt of the indication of sex, the quoting engine records the response and then can request further information if desired in a third text message send to user's phone 140. For example, the third text (in step 340) can request user residential information, e.g., “Thanks for sending your gender. Reply to text with home ZIP code”. Then, upon returning to step 345, the user can text his or her ZIP code in a third response text using mobile phone 140, which is then recorded by the quoting engine.

Returning again to step 340, and the quoting engine 108 sends an additional fourth text referencing the answer received, and including a new request. For example, in one embodiment this fourth text might say “thanks for sending your ZIP code. Reply to text with email address and we will send you our quote.” The user can then, in again executing step 345, send a fourth response text including his or her email address which will be recorded by the quoting engine and used by the insurance company to contact the user either instantly or at a later time.

The process indicated at steps 340 and 345 is repeated until the user has answered all questions necessary to provide a quote. In the embodiment discussed in the last several paragraphs, the questions elicit the user's age, gender, and zip code. It is possible that more or less information could be obtained depending on the needs of the insurance company providing the quotes. And the request of the user's email address is only one of various means of obtaining the user's contact information.

At step 350, quoting engine 108 processes the user's answers and sends a quote based thereon to the user's mobile phone 140. In an exemplary embodiment, quoting engine 108, in a step 355, sends a follow-up email message to the email address submitted by the user. The follow-up email message may, for example, provide information on enrollment in a company's health insurance plan.

In one embodiment, at step 360, transaction processing system 105 also tracks and stores keyword usage and sales of the product(s) associated with the quotes. That is, the number of telephonically received keywords associated with each of the media sources is compiled and compared. The relative number of responses, or ‘hits’, for each keyword enables the advertiser to determine program effectiveness per announcer/media source based on the number of responses received using different keywords over time. Additionally, the advertiser is able to determine which of the plurality announcer/media sources used resulted in more actual sales than others. All of this enables the advertiser to more efficiently devote resources to the announcers/media sources based on the number of keywords received, total sales generated based on keyword, and other statistical information.

In another embodiment, a different keyword is respectively included in each of two or more announcements broadcast by a particular media source or by a particular announcer. The present system then tracks the number of times each of the keywords is telephonically received from users listening to the media source, to determine the relative effectiveness of the announcements, or alternatively, the relative effectiveness of the announcer.

While preferred embodiments of the disclosed subject matter have been described, so as to enable one of skill in the art to practice the disclosed subject matter, the preceding description is intended to be exemplary, and should not be used to limit the scope of the invention, which is determined by reference to the following claims.

What is claimed is:

1. A method for marketing a product using an announcement broadcast by a media source comprising:
associating a keyword with the media source;
providing instructions, to be included in the announcement, to send a first text message including the keyword to a text messaging number, to receive a quote for the product;
receiving the first text message, including the keyword, from a wireless telecommunication device;
sending a second text message to the telecommunication device in response to receiving the first text message, wherein the second text message contains instructions indicating required information that must be received from the telecommunication device to generate the quote;
receiving, from the telecommunication device, a third text message including the required information;
generating the quote, using the required information; and
sending the quote to the telecommunication device.

2. The method of claim 1 comprising:
using an SMS short code number as the number in the instructions in the announcement.

3. The method of claim 1, further including:
iteratively performing the steps of sending a second text message and receiving a third text message until information sufficient to provide a quote has been received.

4. The method of claim 1, wherein the quote is included in a text message sent to the telecommunication device.

5. The method of claim 1, wherein the quote is included in a message sent to a web browser running on the telecommunication device.

6. The method of claim 1, wherein the quote is sent via email to an email address supplied by the listener.

7. The method of claim 1, wherein the second message contains instructions indicating that the quote will be sent in response to receiving a message containing specific information indicated in the instructions.

8. The method of claim 7, wherein the specific information includes the age and gender of the listener.

9. The method of claim 1, wherein the product is an insurance policy.

10. The method of claim 1, wherein the method is a method for marketing a service.

11. A method for marketing a product using a plurality of media sources, each broadcasting respective announcements, the method comprising:
establishing a unique keyword for each one of the media sources;
including, in the announcements, instructions to send a text message comprising the respective unique keyword, to a text messaging number, to receive a quote for the product; and
receiving the text message including the respective unique keyword from each of a plurality of wireless telecommunication devices in response to one of the announcements;
wherein the number of times each said keyword is telephonically received is compiled to determine relative effectiveness of the media sources in marketing the product.

12. A method for marketing a product using an announcement broadcast by a media source comprising:
including, in the announcement, instructions to send an initial text message including a unique keyword to a text messaging number to receive a quote for the product;
receiving the initial text message from a wireless telecommunication device;
sending an instructive message to the telecommunication device in response to receiving the initial text message, wherein the instructive message contains instructions indicating required information that must be received from the telecommunication device to generate the quote;
receiving, from the telecommunication device, a quote request message including the required information; and
sending the quote to the telecommunication device in response to receiving the quote request message.

13. The method of claim 12, wherein the instructive message and the quote request message are sent via a text messaging service.

14. The method of claim 12, wherein the instructive message and the quote request message are sent to a web browser running on the wireless telecommunication device.

15. A method for marketing a product using an announcement broadcast by a media source comprising:
establishing a keyword for the media source;
including, in the announcement, instructions to send an initial text message comprising the keyword, to a text messaging number, to receive a quote for the product;
receiving the initial text message including the keyword, from a user of a wireless telecommunication device, via the device, in response to the announcement having been heard by the user of the device; and
sending the quote to the to the telecommunication device via a responsive text message.

16. The method of claim 15, wherein the quote is sent to the user via a web browser running on the telecommunication device.

17. The method of claim 15, further including, prior to sending the quote to the user:
sending a reply message to the telecommunication device in response to receiving the initial message, wherein the reply message contains instructions indicating required information that must be received from the telecommunication device to generate the quote.

18. The method of claim 15, wherein the method is a method for marketing a service.

19. A method for evaluating relative marketing effectiveness of media sources comprising:
establishing a first keyword for a first media source and a second keyword for a second media source; and
compiling the number of times each of the first and the second keywords are telephonically received from users in response to the first keyword and the second keyword being broadcast by the first media source and the second media source, respectively.

20. A method for evaluating relative effectiveness of announcements made by a media source comprising:
including a first keyword in a first announcement broadcast by the media source;
including a second keyword in a second announcement made by the media source; and
tracking the number of times each of the first and second keywords are telephonically received from users listening to said media source to determine the relative effectiveness of the first and second announcements.
